(19) United States
(12) Patent Application Publication
(10) Pub. No.: US 2015/0301073 A1
(43) Pub. Date: Oct. 22, 2015

(54) Light spectra search for cancer

(71) Applicant: Michael Lewis Moravitz, Fairfax, VA (US)

(72) Inventor: Michael Lewis Moravitz, Fairfax, VA (US)

(21) Appl. No.: 14/545,684

(22) Filed: Jun. 8, 2015

(51) Int. Cl. G01N 37/00; G01N 21/25

(52) U.S. Cl. CPC G01N 37/005; G01N 21/25

(57) ABSTRACT

Different Light Spectra Might Be Used to Find the Cause of Cancer in Diseased Tissue.

Description: Some cancers may be caused by invasive organisms, and perhaps they can be seen through powerful microscopes using different light spectra instead of just intense magnification. This might lead to better treatments, prevention methods, or even cures.

Research should be conducted on the cancerous tissue of deceased patients to determine if these organisms are present by this new procedure using different light spectra. Identifying the organism could lead to medicines to kill it, contain it within the body, or prevent it from entering. The existence of the organism is theoretical, however, but this does offer a new avenue for research.

1. Builds on Patents for Electronic Microscopes.
